(19) United States
(12) Patent Application Publication
(10) Pub. No.: US 2026/0323012 A1
(43) Pub. Date: Oct. 15, 2026

(54) TEMPORAL PREDICTION USING CROSS-COMPONENT RESIDUAL MODEL

(71) Applicant: INTERDIGITAL CE PATENT HOLDINGS SAS, PARIS (FR)

(72) Inventors: Franck GALPIN, THORIGNE-FOUILLARD (FR); Philippe BORDES, LAILLE (FR); Edouard FRANCOIS, BOURG DES COMPTES (FR); Charles SALMON-LEGAGNEUR, RENNES (FR)

(21) Appl. No.: 19/476,572

(22) PCT Filed: Apr. 17, 2024
(86) PCT No.: PCT/EP2024/060334

§ 371 Date: Oct. 17, 2025

(30) Foreign Application Priority Data
Apr. 21, 2023 (EP) 23315098.6
Apr. 25, 2023 (EP) 23315101.8

(51) Int. Cl. H04N 19/109; H04N 19/176; H04N 19/186; H04N 19/51

(52) U.S. Cl. CPC H04N 19/109; H04N 19/176; H04N 19/186; H04N 19/51

(57) ABSTRACT

The cross-component model generally describes a relation between the luma samples and associated chroma samples. Using the cross-component model parameters derived based on a neighboring region, the chroma samples of the current block can be predicted from the collated reconstructed luma samples. Because the cross-component model parameters are derived at both the encoder and decoder, these model parameters need not to be signaled explicitly and therefore can reduce signaling overhead. In one implementation, the model parameters of across-component model are obtained that models a relation between at least a temporal prediction of a luma sample (PredY) and a temporal prediction of a chroma sample (PredCb/PredCr). Encoding and decoding method based on the cross-component residual/prediction model are further disclosed.

### CROSS REFERENCE TO RELATED APPLICATIONS

This application claims the benefit of European Patent Application No. 23315098.6, filed on Apr. 21, 2023, and of European Patent Application No. 23315101.8, filed on Apr. 25, 2023, which are incorporated herein by reference in their entirety.

### TECHNICAL FIELD

The present embodiments generally relate to a method and an apparatus for cross-component temporal prediction in video encoding and decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

The cross-component model generally describes a relation between the luma samples and associated chroma samples. Using the cross-component model parameters derived based on a neighboring region, the chroma samples of the current block can be predicted from the collated reconstructed luma samples. Because the cross-component model parameters are derived at both the encoder and decoder, these model parameters need not to be signaled explicitly and therefore can reduce signaling overhead. A particular cross-component model allows to reconstruct the chroma entirely using a filtered version of the luma, which is efficient when the two components are very correlated. The cross-component predicted chroma may be used in replacement of the temporal chroma prediction (using the motion compensated chroma) commonly used in inter-prediction of chroma. However, it might happen that some correlation can be found in other part of the signal.

According to a first aspect, a method of video encoding/decoding is disclosed that comprises obtaining a reconstructed luma sample of a block of a picture; obtaining model parameters of a cross-component model that models a relation between at least a temporal prediction of a luma sample and a temporal prediction of chroma samples; obtaining cross-component predicted chroma samples by predicting chroma samples of the block based on the reconstructed luma samples of the block and the cross-component model with the model parameters; and encoding/decoding the chroma samples based on the cross-component predicted chroma samples.

According to a particular feature, the residual cross-component predicted chroma samples of a block of a picture is derived as a weighted sum of the cross-component predicted chroma samples and the motion compensated predicted chroma samples.

According to another particular feature, the model parameters of a cross-component model models a relation between at least a temporal prediction of a luma sample; at least a temporal prediction of a chroma sample; and a corrected temporal prediction of chroma samples.

According to yet another particular feature, the residual cross-component predicted chroma sample of a first chroma component of a block of a picture is further used the deriving of a residual cross-component predicted chroma sample of a second chroma component of a block of a picture.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding a video according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates the locations of the samples used for derivation of a CCLM.

FIG. 5 illustrates an example of a slope adjustment parameter of a CCLM.

FIG. 6 illustrates the spatial part of the convolutional filter in CCCM.

FIG. 7 illustrates the reference area (with its paddings) used to derive the filter coefficients.

FIG. 8 illustrates the spatial samples used for GL-CCCM.

FIG. 9 illustrates the spatial part of the non-down sampled CCCM luma terms used for convolutional filter.

FIG. 10 illustrates the down-sampling filters used for convolutional filter.

FIG. 11 illustrates a process of cross-component residual model (CCRM) for temporal prediction, according to an embodiment.

FIG. 12 illustrates the luma samples (L0, . . . , L5) in relation to the chroma sample C (shown in a half-pel luma grid) for CCRM, according to an embodiment.

FIG. 13 illustrates a process of cross-component residual model (CCRM) where the cross-component residual prediction and the regular motion compensated prediction are combined according to another embodiment.

FIG. 14 illustrates cross-component successive residual/prediction model according to an embodiment.

FIG. 15 illustrates cross-component successive residual/prediction model according to an embodiment.

FIG. 16 illustrates a generic encoding or decoding method using cross-component residual/prediction model according to an embodiment.

### DETAILED DESCRIPTION

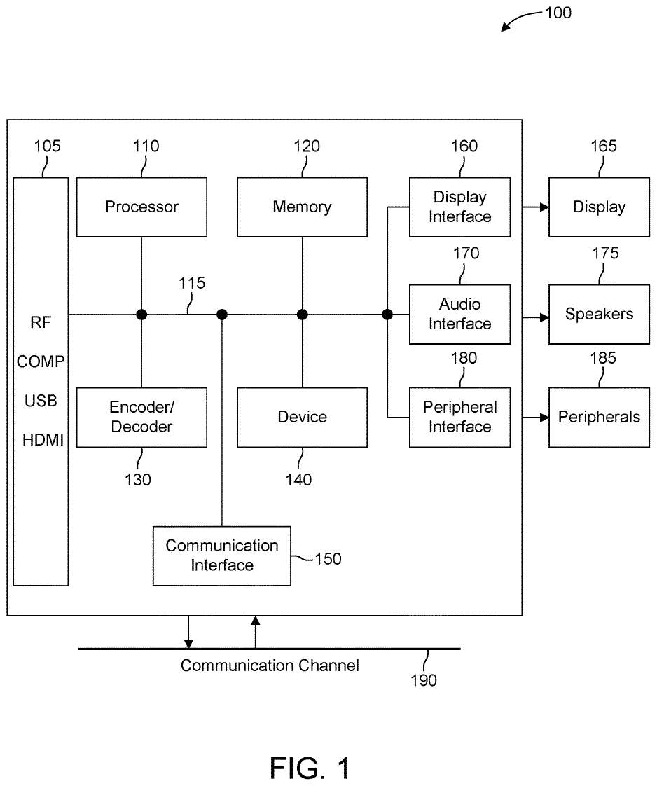

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC (Versatile Video Coding).

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface Ics or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

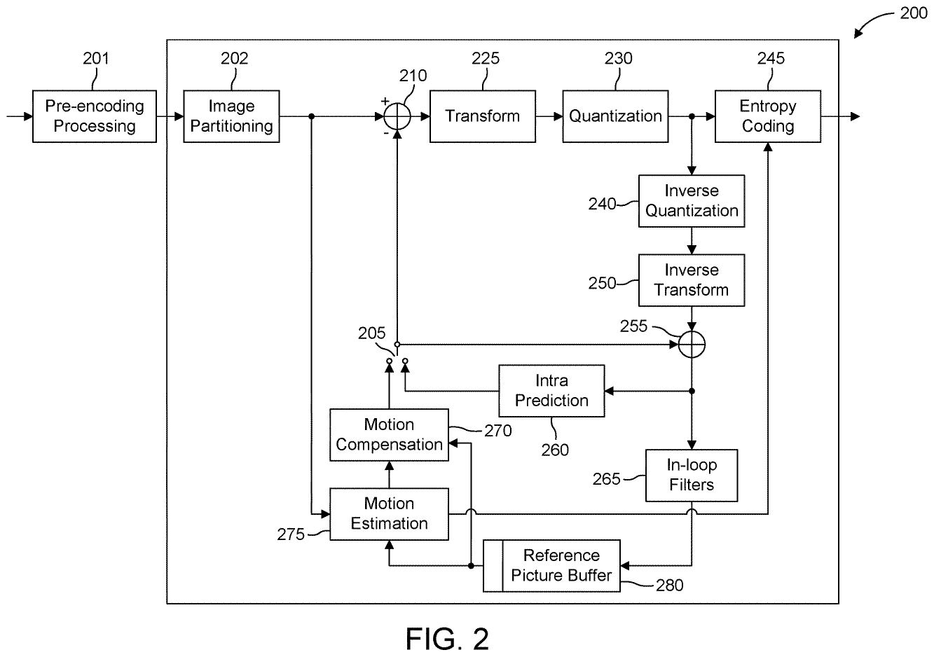

FIG. 2 illustrates an example of a block-based hybrid video encoder 200. Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs (Coding Units). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/nter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements such as the picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset)/ALF (Adaptive Loop Filter) filtering to reduce encoding artifacts. The filtered image is stored in a reference picture buffer (280).

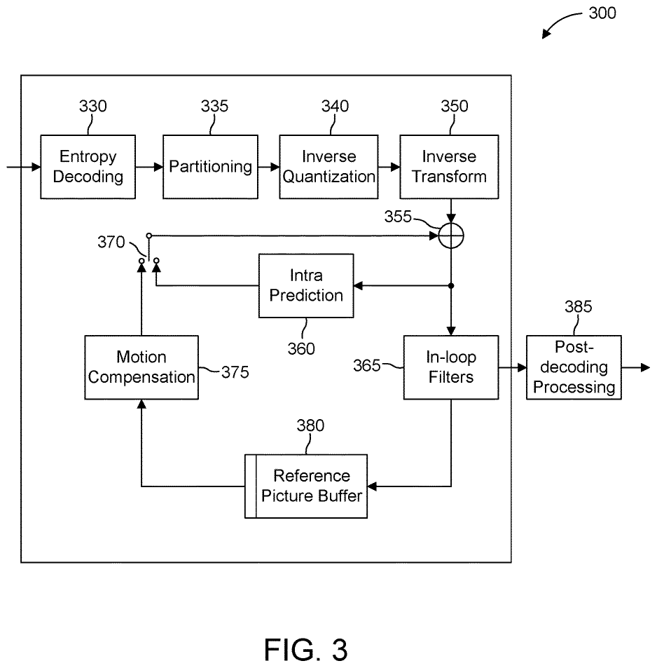

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380). Note that, for a given picture, the contents of the reference picture buffer 380 on the decoder side is identical to the contents of the reference picture buffer 280 on the encoder side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

### Cross-Component Linear Model (CCLM) for Intra Prediction

To reduce the cross-component redundancy, a Cross-Component Linear Model (CCLM) prediction mode is used in the VVC, for which the chroma samples are predicted based on the reconstructed luma samples of the same CU by using a linear model as follows:

pred_{C}(i,j)=α·rec_{L}(i,j)+β (eq.1)

where pred_{C}(i, j) represents the predicted chroma samples in a CU and rec_{L}(i, j) represents the down-sampled reconstructed luma samples of the same CU. The CCLM parameters (α and β) are derived from neighboring chroma samples (top row and left column) and their corresponding down-sampled luma samples (LM mode). In a variant, at most four neighbouring chroma samples are used. In another variant, the neighboring chroma samples are selected from top only (LM-A), or left only (LM-L) and the selected mode is signaled.

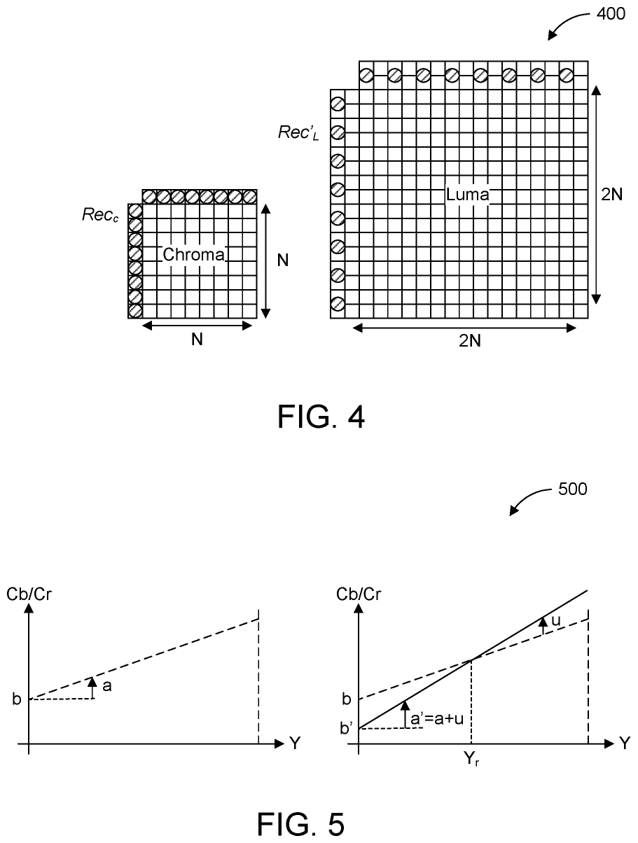

FIG. 4 (400) shows an example of the location of the left and above samples and the sample of the current block involved in the CCLM mode. The four neighboring luma samples at the selected positions are down-sampled and compared four times to find two smaller values: x⁰_{A} and x¹_{A}, and two larger values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and Y_{b} are derived as:

Xₐ=(x⁰_{A}+x¹_{A}+1)>>1; X_{b}=(x⁰_{B}+x¹_{B}+1)>>1;

Yₐ=(y⁰_{A}+y¹_{A}+1)>>1; Y_{b}=(y⁰_{B}+y¹_{B}+1)>>1 (eq.2)

Finally, the linear model parameters a and 0 are obtained according to the following equations.

α=(Yₐ−Y_{b})/(Xₐ−X_{b}) (eq.3)

β=Y_{b}−α·X_{b} (eq.4)

### Multi-Model LM (MMLM) and Other CCLM Variants

There exist several variants to CCLM, where a) the location and/or the number of the neighboring samples used to derive the model, b) the method to derive the linear model parameters (α, β), or c) the luma down-sampling filter, may differ. For example, in ECM (Enhanced Compression Model), the CCLM included in VVC is extended by adding three Multi-model LM (MMLM) modes. In each MMLM mode, the reconstructed neighboring samples are classified into two classes using a threshold which is the average of the luma reconstructed neighboring samples, as shown in FIG. 5. The linear model of each class is derived using the Least-Mean-Square (LMS) method or the previous CCLM method for example.

In yet another variant of CCLM, a slope adjustment is applied to cross-component linear model (CCLM) and to Multi-model LM prediction. The adjustment is tilting the linear function which maps luma values to chroma values with respect to a center point determined by the average luma value of the reference samples, as depicted in FIG. 5 (500).

### Convolutional Cross-Component Model (CCCM) for Intra Prediction

The convolutional cross-component model (CCCM) predicts chroma samples from reconstructed luma samples in a similar spirit as done by CCLM. As with CCLM, the reconstructed luma samples may be down-sampled to match the lower resolution of the chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). In a variant, the multi-model CCCM mode can be selected for PUs which have at least 128 reference samples available.

A pixel can include several (e.g., three) color components. For ease of notations, the luma component may be called the luma sample and the chroma component may be called the chroma sample, and the luma sample and chroma sample representing the same pixel are considered as collocated. Similarly, for an image block with several color components, the luma block and chroma block of this image block are considered as collocated. Besides, in the variant of three color components, a luma sample, a first chroma sample (e.g. chroma Cr) and a second chroma sample (e.g. chroma Cb) are considered in the following.

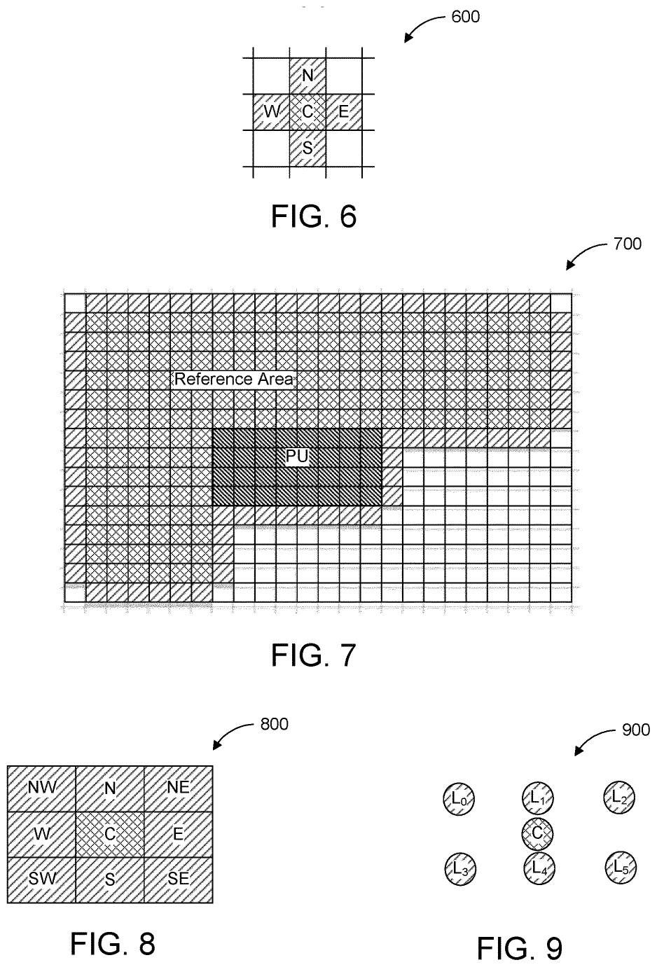

CCCM uses a convolutional 7-tap filter consisting of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 6.

The nonlinear term P is represented as power of two of the center luma sample C, offset by midVal=(1<<(bitDepth−1)) and scaled to the sample value range of the content:

P=(C*C+midVal)>>bitDepth.

That is, for 10-bit content midVal is 512 and P is calculated as:

P=(C*C+512)>>10.

The bias term B represents a scalar offset between the input and output (similarly to the offset term in CCLM) and is set to the middle chroma value (512 for 10-bit content).

Output of the filter is calculated as a convolution between the filter coefficients cᵢ and the input values and clipped to the range of valid chroma samples:

predChromaVal=c₀C+c₁N+c₂S+c₃E+c₄W+c₅P+c₆B.

The filter coefficients cᵢ are calculated by minimizing MSE (Mean Squared Error) between predicted and reconstructed chroma samples in the reference area. FIG. 7 illustrates the reference area which consists of 6 lines/columns of chroma samples above and left of the PU. Reference area extends one PU width to the right and one PU height below the PU boundaries. The reference area is adjusted to include only available samples. One additional line and column of samples are attached to the reference area (700) to support the “side samples” of the plus shaped spatial filter and are padded when in unavailable areas.

Denote

$${a}_{i} = \{ \begin{matrix}C , i & = 0 \\ N , i & = 1 \\ S , i & = 2 \\ E , i & = 3 \\ W , i & = 4 \\ P , i & = 5 \\ B , i & = 6\end{matrix} .$$

The MSE minimization is performed by calculating an autocorrelation matrix m_{i,j}=Σ_{x∈area} aᵢ(x)·aⱼ(x) for the luma input and a cross-correlation vector between the luma input and chroma output.

Autocorrelation matrix is LDL decomposed and the final filter coefficients are calculated using back-substitution. The process follows roughly the calculation of the ALF filter coefficients in ECM, however LDL decomposition (i.e., alternative Cholesky decomposition) was chosen instead of Cholesky decomposition to avoid using square root operations. The calculation uses only integer arithmetic.

### Gradient and Location Based Convolutional Cross-Component Model (GL-CCCM)

In a variant named GL-CCCM, the GL-CCCM filter for the prediction is:

predChromaVal=c₀C+c₁Gy+c₂Gx+c₃Y+c₄X+c₅P+c₆B,

where Y and X parameters are the vertical and horizontal locations of the center luma sample and they are calculated with respect to the top-left coordinates of the block, and Gy and Gx are the vertical and horizontal gradients, respectively, and are calculated as:

Gy=(2N+NW+NE)−(2S+SW+SE),

Gx=(2W+NW+SW)−(2E+NE+SE),

where FIG. 8 illustrates the sample positions for samples NW, NE, SW and SE.

In another variant, multiple (4) down-sampling filters may be used to derive the input samples to be weighted with the coefficients. The down-sampling filter model is signaled per CU and the prediction of the chroma samples is derived as follows:

predChroma=c0*H(C)+c1*G1(C)+c2*G2(C)+c3*G3(C)+c4*G4(C)+c5*P+c6*B Model 1

predChroma=c0*H(C)+c1*H(W)+c2*H(E)+c3*G1(C)+c4*G1(W)+c5*G1(E)+c6*B Model 2

predChroma=c0*H(C)+c1*H(N)+c2*H(S)+c3*G2(C)+c4*G2(N)+c5*G2(S)+c6*B Model 3

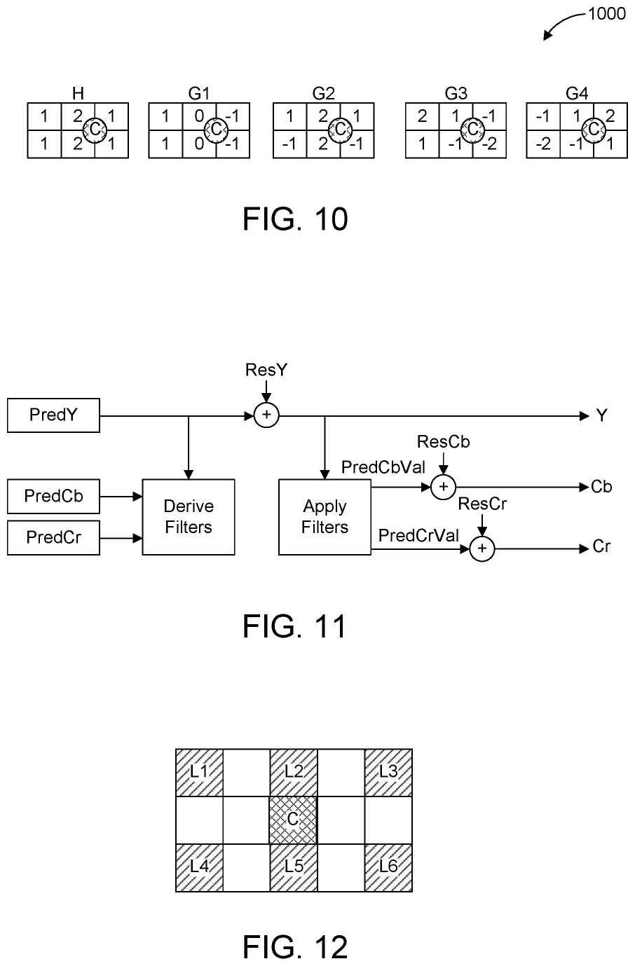

predChroma=c0*H(C)+c1*H(NE)+c2*H(SW)+c3*G4(C)+c4*G4(NE)+c5*G4(SW)+c6*B Model 4

where H(⋅), G1(⋅), G2(⋅), G3(⋅), G4(⋅) are downsampling filters applied on luma samples as shown in FIG. 10 (1000).

### Cross-Component Residual Model (CCRM) for Temporal Prediction

In another variant, a 8-tap filter consisting of 6 spatial luma samples, a nonlinear term, and a bias term is used for the prediction of the chroma samples using only the luma component in inter coded blocks. FIG. 11 illustrates a process of cross-component residual modeling (CCRM) for temporal prediction, according to an embodiment. The spatial luma samples (L0, . . . , L5) are obtained from the luma grid by selecting the 6 luma samples closest to the chroma position C without down sampling the luma as shown in FIG. 12. The predicted chroma value is obtained as:

predChromaVal=c0L0+c1L1+c2L2+c3L3+c4L4+c5L5+c6 nonlinear((L0+L3+1)>>1)+c7B,

where nonlinear is the CCCM's nonlinear operator and B is bias.

The filter coefficients are derived using ECM's division-free Gaussian elimination method and the necessary offsets are applied to samples prior to filter derivation.

Intra reference samples may be used as additional input samples in filter derivation when the block has less than 64 chroma samples. CCCM's design of at most 6 rows and columns of intra reference samples is used. Blocks having 256 chroma samples or more are divided into subblocks that have at most 256 chroma samples. Subblocks containing zero luma residual are skipped.

The CCRM tool allows to reconstruct the chroma entirely using a filtered version of the luma, which is efficient when the two components (luma and chroma) are very correlated. Advantageously, the cross-component chroma prediction may currently be used in replacement of the temporal chroma prediction (i.e. using the motion compensated chroma) commonly used in inter-prediction of chroma. However, it might happen that some correlation can be further found either in the temporal chroma prediction (i.e. using the motion compensated chroma), or between the 2 chroma components.

At least some embodiments relate to a method for video encoding or decoding using model parameters of a cross-component model that models a relation between at least a temporal prediction of a luma sample and a temporal prediction of chroma samples. Advantageously, the CCRM tool is enhanced by further exploiting the correlations between the temporal chroma prediction and/or a predicted chroma prediction from luma reconstruction for the 2 chroma components to further improve the chroma prediction from the luma.

### Cross-Component Residual/Prediction Model

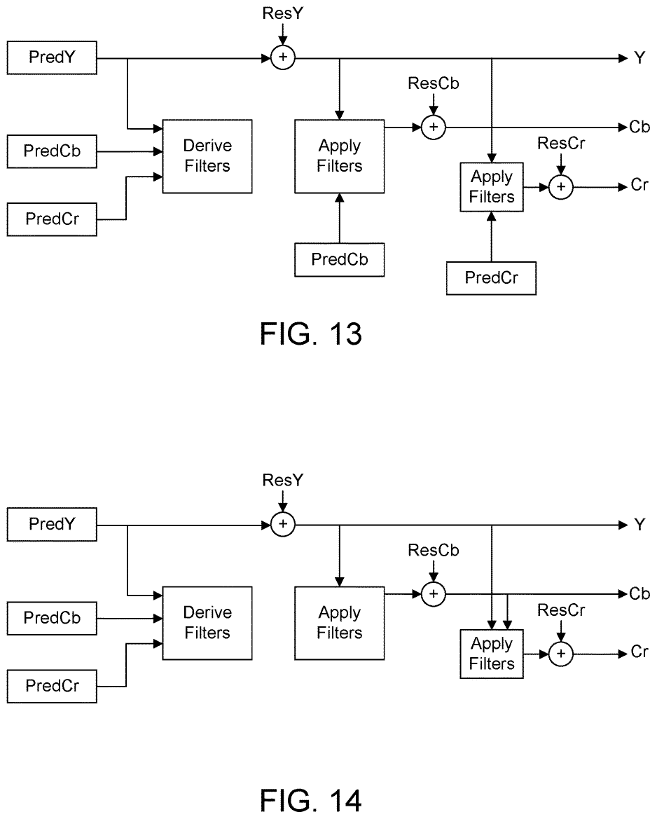

According to a first embodiment, the cross-component model represents a relation between at least a temporal prediction of a luma sample and a temporal prediction of chroma samples. FIG. 13 illustrates a process of cross-component residual model (CCRM) for temporal prediction according to a first embodiment. Advantageously, the embodiment of FIG. 13 mixes the cross-component residual prediction and the regular motion compensated prediction of each of chroma samples.

In a first embodiment, each chroma components is predicted using a filter which use both luma reconstruction and the chroma prediction. The filter coefficients are derived as before, for example for Cb component, and a cross-component predicted chroma sample (PredCbRm) is obtained by:

predCbRm=c₀L0+c₁L1+c₂L2+c₃L3+c₄L4+c₅L5+c₆ nonlinear((L0+L3+1)>>1)+c₇B,

then the final chroma prediction, called residual cross-component predicted (PredCbVal) chroma sample, is derived as a weighted sum of the cross-component predicted chroma samples (PredCbRm) and the motion compensated predicted (PredCb) chroma samples as follow:

predCbVal=w*predCbRM+(1−w)*predCb

where w is a fixed weight of the weighted sum. In practice, to avoid division, an integer version is computed as:

predCbVal=(w*predCbRM+((1<<N)−w)*predCb)>>N

With for example, w=16 and N=5 for an average of the 2 chroma predictions.

The same process is applied for the Cr chroma component. The coefficients are found using the same process as CCRM.

In a variant, an indication of a weight used in the weighted sum is encoded/decoded. Accordingly the weight w is signaled from the encoder to the decoder, for example at slice level or block level. At block level, a common signaling can be used to switch between regular chroma prediction (using motion compensation), CCRM prediction and mixed prediction, for example:

| | |
|---|---|
| coding_unit( x0, y0, cbWidth, cbHeight, cqtDepth, treeType, modeType ) { | Descriptor |
| ... | |
| If (inter_pred_idc[ x0 ][ y0 ] ) { | |
| chroma_pred_mode_mc | ae(v) |
| if ( ! chroma_pred_mode_mc ) | |
| chroma_pred_mode_rm | ae(v) |
| if (!chroma_pred_mode_mc && ! chroma_pred_mode_rm ) | |
| chroma_pred_mode_weight | ae(v) |

where
chroma_pred_mode_mc: when the flag is true, the chroma prediction uses the default motion compensation process.
chroma_pred_mode_rm: when the flag is true, the chroma uses pure residual mode CCRM
chroma_pred_mode_weight: when both modes above are false, an index gives the weight of the default prediction, for example:

| Index value | Weight of the MC prediction |
|---|---|
| 0 | 8/32 |
| 1 | 16/32 |
| 2 | 24/32 |

Accordingly, an indication (chroma_pred_mode_mc, chroma_pred_mode_rm, chroma_pred_mode_weight) specifying whether the motion compensated predicted (PredCb) chroma samples, the cross-component predicted chroma samples (PredCbRm) or the residual cross-component predicted chroma samples (PredCbVal) are selected for the encoding/decoding the chroma samples.

In another variant, the weight used in the weighted sum is derived using reconstructed chroma samples of a neighboring template. Thus, the coefficient w is implicitly derived by using a template around the block (as in CCCM) to get the optimal w value. Indeed, the whole process for predicting the chroma and reconstructing the chroma as shown on FIG. 13 is applied on the template and the best weight is determined that corresponds to the best reconstructed chroma where best stand for the reconstructed chroma that minimizes the MSE.

In yet another variant, a best mode for temporal chroma prediction that selects among the motion compensated predicted chroma samples, or the cross-component predicted chroma samples or the residual cross-component predicted chroma samples for the encoding/decoding is also determined based on the reconstructed luma samples of a neighboring template and reconstructed chroma samples of a neighboring template. Therefore, by applying the process in a template around the block, the best mode/index is selected for the block. The best mode/index is the one minimizing the difference between the predicted samples and the final reconstructed samples in the template.

In yet another variant, the model parameters of a cross-component model models a relation between at least a temporal prediction of a luma sample (PredY), at least a temporal prediction of a chroma sample (PredCb/PredCr), and at least a corrected temporal prediction of chroma samples (predCbRM). In this variant, the regular chroma prediction (e.g. using motion compensation) is included in the derivation of the cross-component weighting. For example:

predCbRM=c₀L0+c₁L1+c₂L2+c₃L3+c₄L4+c₅L5+c₆ nonlinear((L0+L3+1)>>1)+c₇B+c₈ PredCb

where c8 is a weight of the PredCb prediction sample. C8 is derived together with the other coefficients c0, . . . c7 with MSE minimization on the template. In this case, the same parameters used for the regular chroma prediction (for example motion vector and reference indexes) are used for the neighboring template. In another variant, several samples around the current chroma sample of the chroma prediction may be used:

predCbRM=c₀L0+c₁L1+c₂L2+c₃L3+c₄L4+c₅L5+c₆ nonlinear((L0+L3+1)>>1)+c₇B+c₈·PredCb0+c₉·PredCb1+c₁₀·PredCb2+c₁₁·PredCb3+c₁₂·PredCb4

where Cb0, Cb1, Cb2 and Cb3 are the co-located chroma prediction sample, the left, right, above and below chroma prediction samples respectively.

In yet another variant, the weighting include some luma gradient samples (Gy,Gx) and/or sample position (X,Y) in same way as for GL-CCCM formulae.

### Cross-Component Successive Residual/Prediction Model

According to a second embodiment, the cross-component model represents a relation between at least a temporal prediction of a luma sample and at least temporal prediction of a first chroma sample. FIG. 14 illustrates a process of cross-component successive residual/prediction model (CCRM) for temporal prediction according to a second embodiment. For instance, the embodiment of FIG. 14 mixes the reconstructed chroma sample of a first chroma component (Cb) with at least a reconstructed luma sample to generate a cross-component residual prediction of a second chroma component (PredCrVal). In the second embodiment, the prediction of the Cr component (or alternatively the Cb component) is used the Cb reconstruction (resp. Cr reconstruction) to improve the prediction.

First, the Cb component is processed as before:

predCbVal=c₀L_{O}+c₁L1+c₂L2+c₃L3+c₄L4+c₅L5+c₆ nonlinear((L0+L3+1)>>1)+c₇B,

Then the Cr component is computed as:

predCrVal=c₀L0+c₁L1+c₂L2+c₃L3+c₄L4+c₅L5+c₆ nonlinear((L0+L3+1)>>1)+c₇B+c₈Cb

where Cb is the reconstructed collocated Cb value.

Accordingly, obtaining cross-component predicted chroma samples (PredCbVal, PredCrVal) by predicting chroma samples of the block based on the reconstructed luma samples of the block and the cross-component model with the model parameters further comprises predicting chroma samples of a first chroma component (Cb) of the block based on the reconstructed luma samples of the block and the cross-component model with the model parameters to generate cross-component predicted chroma samples (PredCbVal) of the first chroma component of the block. Then, reconstructed chroma samples (Cb) of the first chroma component of the block are obtained based on the cross component predicted chroma samples (PredCbVal) of the first chroma component of the block by adding a residual of the first chroma component of the block (resCb); and the cross-component predicted chroma samples (PredCrVal) of the second chroma component of the block are obtained based on at least one of the reconstructed luma samples of the block, on at least one of the reconstructed chroma samples of the first component and the cross-component model with the model parameters.

In a variant, more than one Cb values are added to predict the Cr values (for example left/right, top/left values), or non linear term depending on the Cb value.

In another variant, the Cr filter uses the reconstructed Cb value to derive the filter (and uses it for applying).

Cross-Component Residual/Prediction Model with Successive Residual/Prediction Model

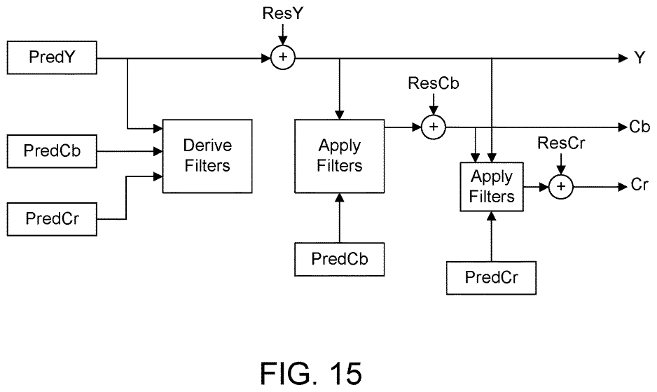

According to a third embodiment, the first and the second embodiment are combined. FIG. 15 illustrates a process of cross-component successive residual/prediction model (CCRM) for temporal prediction according to a third embodiment. For instance, the embodiment of FIG. 15 mixes the weighted prediction of the motion predicted chroma and residual mode for one chroma component with a second chroma component. As shown in FIG. 15, both two aspects of FIG. 13 and FIG. 14 are combined: a weighted prediction of the motion predicted chroma and residual mode is used for the Cb component, and the Cr component additionally uses the reconstructed Cb component to compute the prediction.

Accordingly, the method comprises obtaining motion compensated predicted (PredCb) chroma samples of a first chroma component of a block of a picture and motion compensated predicted (PredCr) chroma samples of a second chroma component of a block of a picture; predicting chroma samples (PredCbRm) of the first chroma component (Cb) of the block based on the reconstructed luma samples of the block and the cross-component model with the model parameters to generate cross-component predicted chroma samples (PredCbRm) of the first chroma component of the block; obtaining residual cross-component predicted (PredCbVal) chroma samples of the first chroma component of a block of a picture as a weighted sum of the cross-component predicted chroma samples (PredCbRm) of the first chroma component of the block and the motion compensated predicted (PredCb) chroma samples of the first chroma component of the block; obtaining reconstructed chroma samples of the first chroma component of the block based on the residual cross component predicted chroma samples (PredCbVal) of the first chroma component of the block; and predicting chroma samples (PredCrRM) of the second chroma component of the block based on the reconstructed luma samples of the block, on the reconstructed chroma samples of the first component and the cross-component model with the model parameters to generate cross-component predicted chroma samples (PredCrRm) of the second chroma component of the block; and obtaining residual cross-component predicted (PredCrVal) chroma samples of the second chroma component of a block of a picture as a weighted sum of the cross-component predicted chroma samples (PredCbRm) of the second chroma component of the block and the motion compensated predicted (PredCr) chroma samples of the second chroma component.

Adding resY Before Deriving Filters

According to a fourth embodiment, the model parameters of a cross-component model are obtained by filtering reconstructed luma samples (PredY+ResY) and a temporal prediction of chroma samples (PredCb/PredCr). In this variant of CCRM, the addition of resY to PredY is achieved prior to deriving the filters.

In variants of the embodiments above, the addition of resCb or resCr is achieved prior to deriving the filters.

Mixing the Temporal Chroma Prediction with the Reconstructed Chroma from CCRM

According to a fifth embodiment, cross-component predicted chroma samples (PredCbRm) are obtained by predicting chroma samples (PredCbRm) of the block based on the reconstructed luma samples of the block and the cross-component model with the model parameters; then reconstructed chroma samples (RecoCb) of the block are obtained based on the residual cross component predicted chroma samples (filtered(Resy)) of the block; and refined reconstructed chroma samples (RecoCb2) of the block are determined as a weighted sum of the reconstructed chroma samples (RecoCb) and the motion compensated predicted (PredCb) chroma samples of the block. In this variant of CCRM (as disclosed in FIG. 11), the temporal chroma prediction with the reconstructed chroma RecoCb from CCRM. For instance, for Cb component, the final reconstructed chroma RecoCb2 is obtained as follows:

RecoCb=PredCb+Filtered(ResY)+ResCb

RecoCb2=w0*PredCb+w1*RecoCb

In case of additional input samples in filter derivation are used (ex: block has less than 64 chroma samples), this may introduce dependency with the reconstruction of neighboring blocks if the current block is coded in inter mode.

In a variant embodiment of the filter derivation, intra reference samples may be used as additional input samples in filter derivation when the block has less than 64 chroma samples. According to a sixth embodiment, in case of the current block is coded in inter mode and if additional input samples in filter derivation are used, the additional input samples are selected from reconstructed samples of the reference frame(s) used to build the prediction of the current block with motion compensation of reference block(s). For example, one may use the reference samples situated on top and/or at left of the reference block(s).

### Reducing Complexity of CCRM

According to a seventh embodiment, that may be combined with the previous ones, the complexity of the derivation of the CCRM model is reduced. In the prior-art, the derivation of the CCRM model uses inter luma and inter chroma predictions built with regular motion compensation process, i.e. uses sub-pel interpolation filters for performing motion compensation to obtain predY, predCb and predCr. In this embodiment, the predCb and predCr are computed using lower motion accuracy, for instance, full-pel motion compensation using integer part of the motion vectors values, therefore not using interpolation filter but block copy. This approach beneficially reduces the number of operations significantly. Alternatively, interpolation filters of lower length than the length used by default for sub-pel interpolation are used, in order to reduce the number of operations needed for the interpolation. In another variant, the motion compensation is simplified for the chroma component, for example using bilinear interpolation instead of 6-tap filter.

Generic Encoding/Decoding Method with Cross-Component Residua/Prediction Model

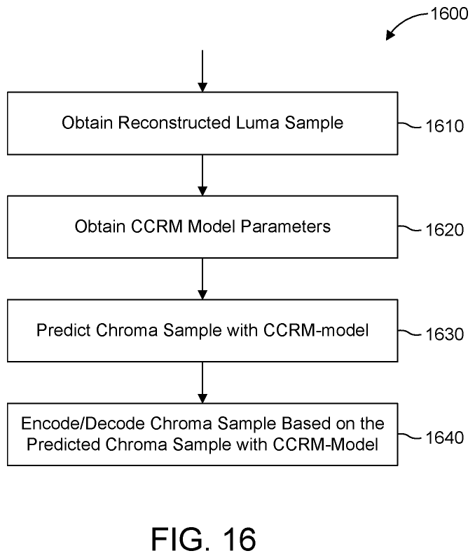

FIG. 16 illustrates generic encoding/decoding method with cross-component residual/prediction model. The method of video encoding/decoding, comprising in a first step (1610) obtaining a reconstructed luma sample of a block of a picture. In a second step (1620), model parameters are obtained of a cross-component model that models a relation between at least a temporal prediction of a luma sample and a temporal prediction of chroma samples. In a third step (1630), cross-component residual predicted chroma samples by predicting at least a chroma sample of the block based on the reconstructed luma sample of the block and the cross-component model with the model parameters. The cross-component predicted chroma sample is used in encoding/decoding the chroma samples of block based.

Various methods and other aspects described in this application can be used to modify modules, for example, the inter prediction modules (270, 375), of a video encoder 200 and decoder 300 as shown in FIG. 2 and FIG. 3. Moreover, the present aspects are not limited to ECM, VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals which neighbor region is selected. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video encoding, comprising:
obtaining reconstructed luma samples of a block of a picture;
obtaining motion compensated predicted chroma samples of the block;
obtaining model parameters of a cross-component model that models a relation between at least a motion compensated predicted luma sample and a motion compensated predicted chroma sample;
obtaining cross-component predicted chroma samples by applying the cross-component model with the model parameters to the reconstructed luma samples of the block;
obtaining residual cross-component predicted chroma samples of the block as a weighted sum of the cross-component predicted chroma samples and the motion compensated predicted chroma samples; and
encoding the chroma samples of the block based on the residual cross-component predicted chroma samples.

2. (canceled)

3. The method of claim 1, further comprising:
encoding an indication of a weight used in the weighted sum.

4. The method of claim 1, further comprising:
encoding an indication specifying whether the motion compensated predicted chroma samples, the cross-component predicted chroma samples or the residual cross-component predicted chroma samples are selected for the encoding of chroma samples.

5. The method of claim 1, further comprising:
obtaining a weight used in the weighted sum using reconstructed chroma samples of a neighboring template.

6. The method of claim 1, further comprising:
obtaining a best mode for temporal chroma prediction enabling a selection of the motion compensated predicted chroma samples, or the cross-component predicted chroma samples or the residual cross-component predicted chroma samples for the encoding using reconstructed chroma samples of a neighboring template.

7-15. (canceled)

16. A method of video decoding, comprising:
obtaining reconstructed luma samples of a block of a picture;
obtaining motion compensated predicted chroma samples of the block;
obtaining model parameters of a cross-component model that models a relation between at least a motion compensated predicted luma sample and a motion compensated predicted chroma sample;
obtaining cross-component predicted chroma samples by applying the cross-component model with the model parameters to the reconstructed luma samples of the block;
obtaining residual cross-component predicted chroma samples of the block as a weighted sum of the cross-component predicted chroma samples and the motion compensated predicted chroma samples; and
decoding the chroma samples of the block based on the residual cross-component predicted chroma samples.

17. (canceled)

18. The method of claim 16, further comprising:
decoding an indication of a weight used in the weighted sum.

19. The method of claim 16, further comprising:
decoding an indication specifying whether the motion compensated predicted chroma samples, the cross-component predicted chroma samples or the residual cross-component predicted chroma samples are selected for the decoding of chroma samples.

20. The method of claim 16, further comprising:
obtaining a weight used in the weighted sum using reconstructed chroma samples of a neighboring template.

21. The method of claim 16, further comprising:
obtaining a best mode for temporal chroma prediction enabling a selection of the motion compensated predicted chroma samples, or the cross-component predicted chroma samples or the residual cross-component predicted chroma samples for the decoding using reconstructed chroma samples of a neighboring template.

22-33. (canceled)

34. An apparatus, comprising one or more processors, wherein the one or more processors are configured to:
obtain reconstructed luma samples of a block of a picture;
obtain motion compensated predicted chroma samples of the block;
obtain model parameters of a cross-component model that models a relation between at least a motion compensated predicted luma sample and a motion compensated predicted chroma sample;
obtain cross-component predicted chroma samples by applying the cross-component model with the model parameters to the reconstructed luma samples of the block;
obtain residual cross-component predicted chroma samples of the block as a weighted sum of the cross-component predicted chroma samples and the motion compensated predicted chroma samples; and
encode the chroma samples of the block based on the residual cross-component predicted chroma samples.

35. The apparatus of claim 34, wherein the one or more processors are configured to encode an indication of a weight used in the weighted sum.

36. The apparatus of claim 34, wherein the one or more processors are configured to encode an indication specifying whether the motion compensated predicted chroma samples, the cross-component predicted chroma samples or the residual cross-component predicted chroma samples are selected for the encoding of chroma samples.

37. The apparatus of claim 34, wherein the one or more processors are configured to obtain a weight used in the weighted sum using reconstructed chroma samples of a neighboring template.

38. The apparatus of claim 34, wherein the one or more processors are configured to obtain a best mode for temporal chroma prediction enabling a selection of the motion compensated predicted chroma samples, or the cross-component predicted chroma samples or the residual cross-component predicted chroma samples using reconstructed chroma samples of a neighboring template.

39. An apparatus, comprising one or more processors, wherein the one or more processors are configured to:
obtain reconstructed luma samples of a block of a picture;
obtain motion compensated predicted chroma samples of the block;
obtain model parameters of a cross-component model that models a relation between at least a motion compensated predicted luma sample and a motion compensated predicted chroma sample;
obtain cross-component predicted chroma samples by applying the cross-component model with the model parameters to the reconstructed luma samples of the block;
obtain residual cross-component predicted chroma samples of the block as a weighted sum of the cross-component predicted chroma samples and the motion compensated predicted chroma samples; and
decode the chroma samples of the block based on the residual cross-component predicted chroma samples.

40. The apparatus of claim 39, wherein the one or more processors are configured to decode an indication of a weight used in the weighted sum.

41. The apparatus of claim 39, wherein the one or more processors are configured to decode an indication specifying whether the motion compensated predicted chroma samples, the cross-component predicted chroma samples or the residual cross-component predicted chroma samples are selected for the decoding of chroma samples.

42. The apparatus of claim 39, wherein the one or more processors are configured to obtain a weight used in the weighted sum using reconstructed chroma samples of a neighboring template.

43. The apparatus of claim 39, wherein the one or more processors are configured to obtain a best mode for temporal chroma prediction enabling a selection of the motion compensated predicted chroma samples, or the cross-component predicted chroma samples or the residual cross-component predicted chroma samples using reconstructed chroma samples of a neighboring template.
